(19) United States
(12) Patent Application Publication
(10) Pub. No.: US 2019/0185135 A1
(43) Pub. Date: Jun. 20, 2019

(54) SEALED BOTTOM OF A FRONT END OF AN AIRCRAFT

(71) Applicant: AIRBUS OPERATIONS (S.A.S.), Toulouse (FR)

(72) Inventors: Bernard GUERING, Montrabe (FR); Laurent SAINT-MARC, Montaigut Sur Save (FR)

(21) Appl. No.: 16/225,519

(22) Filed: Dec. 19, 2018

(30) Foreign Application Priority Data
Dec. 19, 2017 (FR) 1762508

(51) Int. Cl. B64C 1/36; B64C 1/06

(52) U.S. Cl. CPC B64C 1/36; B64C 1/068

(57) ABSTRACT

A sealed bottom in the frame of a cockpit with centered pilot is disclosed for increasing the bulk inside the radome and making it possible to improve the optimization of the volumes. The sealed bottom includes a semi-cylindrical central part having four edges that are parallel in pairs, two curved edges, and two straight edges and a planar peripheral part extending at least partially around the central part. The peripheral part (22) is located in the plane of the straight edges of the central part and linked thereto. This configuration will allow to free up space to increase the number of passengers or reduce the size of the aircraft.

### CROSS REFERENCE TO RELATED APPLICATION

This application claims priority to and incorporates by reference French Patent Application Number 1762508, filed Dec. 19, 2017.

### BACKGROUND

### 1. Field of the Invention

The present invention generally relates to an aircraft bulkhead and, more specifically, to a sealed bottom of a front part of an aircraft, and the aircraft provided with such a sealed bottom, and optimizing the space within the front end of the aircraft.

### 2. Description of the Related Art

The front part of an aircraft comprises a separating bulkhead between a non-pressurized space and a pressurized space. The non-pressurized space corresponds to the radome. In most aircraft, the pressurized space separated from the radome by the bulkhead comprises a cockpit and a front technical and equipment hold contiguous to the cockpit below the cockpit. This separating bulkhead is more commonly referred to as the front sealed bottom or bulkhead. The term front specifies that it is the separating bulkhead situated at the front part of the aircraft. Throughout the specification, the bulkhead of the front part of the aircraft will be referred to as the front sealed bottom. In most aircraft, the sealed bottom has a planar surface.

The radome houses a radar antenna. The radar antennas commonly used in commercial aircraft comprise a plate with a rotationally mobile planar surface which requires a significant free volume in the radome to offer the antenna sufficient clearance.

Moreover, the trends in designing and manufacturing aircraft cockpits is leading in particular to the control of an aircraft by a pilot arranged centrally transversally. The control of an aircraft is, for example, ensured by a single pilot or by a pilot assisted by a person not handling the piloting function. In both cases, the pilot is arranged in the central longitudinal axis of the aircraft and the control systems and the instruments are arranged around the pilot, centered thereon. In the case of an additional person assisting the pilot, the co-pilot is offset relative to the pilot behind and to the side.

For example, FR 2999344 relates to a radar antenna comprising a main panel and a plurality of peripheral panels of planar surface that are inclined relative to the planar surface of the main panel. The sealed bottom has a planar surface to which a mechanical support bearing the radar antenna is fixed. Because of the particular geometry of the radar antenna, the bulk of the panels of the radar antenna is smaller than that of the rotationally mobile panel of the radar antenna of known type.

### SUMMARY

The present invention is embodied as a sealed bottom in the frame of a cockpit with a pilot seat located centrally and symmetrically relative to the cockpit making it possible to improve and optimize the volumes.

In an exemplary embodiment, a sealed bottom of a front aircraft part is disclosed comprising two parts: a semi-cylindrical central part having four edges that are parallel in pairs, two curved edges and, two straight edges, and a planar peripheral part extending at least partially around the central part, the peripheral part being located in the plane P of the straight edges of the central part and linked thereto.

In this way, the central part with this semi-cylindrical form moulds to the geometry of the radar antenna while addressing the various constraints to which the front sealed bottom is subjected. The peripheral part makes it possible to adapt the integration of the central part to the aircraft according to the geometry of the front sealed part of the aircraft.

According to one embodiment, the space between the curved edges and the plane P in which the planar peripheral part is located is open.

The present invention is also embodied as a front part of an aircraft comprising a piloting station with at least one centered pilot, delimited partially by a floor, the front part comprising a sealed bottom, wherein the bottom comprises two parts, a semi-cylindrical central part having two opposing edges which are at right angles to the floor, and a concavity which is turned towards the cockpit and includes four edges that are parallel in pairs, two curved top and bottom edges and two straight lateral edges and a planar peripheral part extending at least partially around the central part, the peripheral part being located in the plane of the straight lateral edges of the central part and linked thereto.

The peripheral part forms the link between the central part and the structure of the fuselage so as to close it in a seal-tight manner.

The curved bottom edge of the central part is contiguous to the front end edge of the floor, the space between the bottom edge of the central part and the peripheral part being closed by the floor.

The bottom and top edges of the central part are bracketed by longitudinal stiffeners of the front part and linked directly or indirectly thereto.

The peripheral part extends between the lateral edges of the central part and the foremost frame of the fuselage.

The peripheral part extends between the projection of the bottom edge of the central part on the plane P of the peripheral part and the foremost frame of the fuselage.

The peripheral part partially extends continuously around the central part.

The present invention is also embodied as an aircraft having a front part with the features stated above.

### BRIEF DESCRIPTION OF THE DRAWINGS

For an understanding of embodiments of the disclosure, reference is now made to the following description taken in conjunction with the accompanying drawings, in which:

FIG. 1 is a side view of an example of a commercial aircraft on which an exemplary embodiment of the present invention can be utilized;

FIGS. 2 and 3 are partial perspective views of a nose cone without a radome illustrating the radar antenna and the sealed bottom according to an exemplary embodiment illustrated from the side and from the interior of the cockpit;

FIGS. 4 and 5 are partial views of the radar antenna and of the sealed bottom shown in FIGS. 2 and 3, isolated and associated with the structure of the front part of the aircraft of which only a part is represented seen respectively from the outside and from the inside of the cockpit;

FIG. 6 is a partial perspective view of the front part in which the radome has been removed to reveal the sealed bottom of the radar antenna extracted in an enlarged configuration;

FIG. 7 is a partial perspective view of the structure of the front part provided with the sealed bottom and the radar antenna; and,

FIG. 8 is a cross-sectional plan view along a partial and horizontal plane of the front part provided with the radome in which the sealed bottom and the radar antenna are represented.

In the accompanying drawings, like reference characters refer to the same or similar parts throughout the different views. The drawings are not necessarily to scale, emphasis instead being placed upon illustrating particular principles, discussed below.

### DETAILED DESCRIPTION OF SOME EMBODIMENTS

Some embodiments will now be described with reference to the Figures.

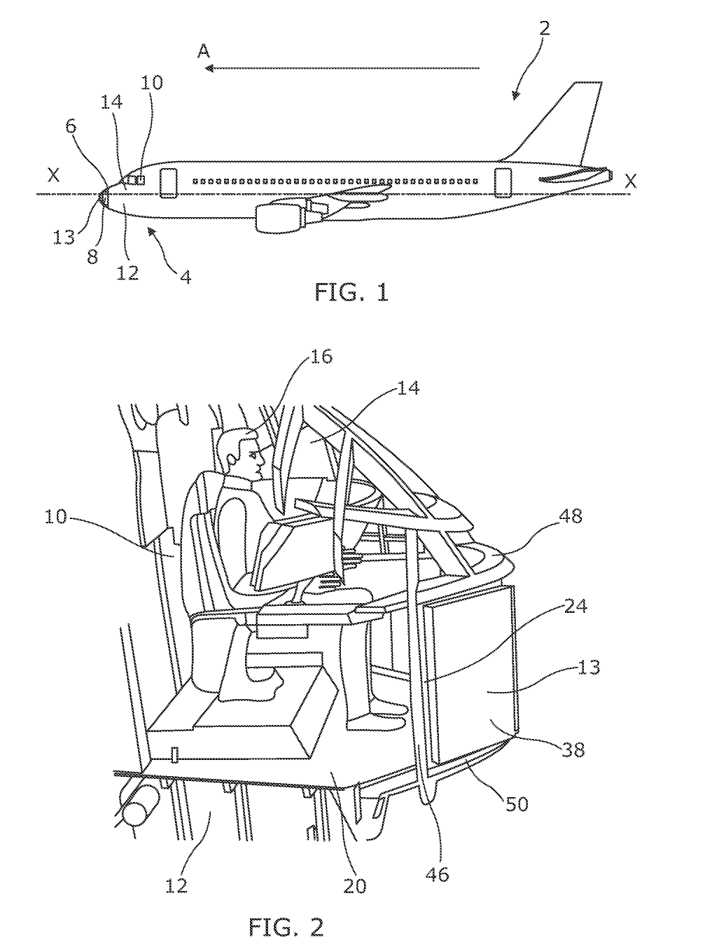

FIG. 1 represents an aircraft 2 having a front part 4 comprising a sealed bottom 6. The terms front and rear are used with reference to the flight direction of the aircraft as shown by the arrow “A” in FIG. 1. The sealed bottom 6 separates a radome 8, which is a non-pressurized space, on one side from a cockpit 10 and a working technical hold 12, which are pressurized spaces on the other side. A radar antenna 13 is housed inside the radome 8. The present invention applies to this type of configuration but can be applied to other types of configurations in which pressurized and non-pressurized spaces are separated.

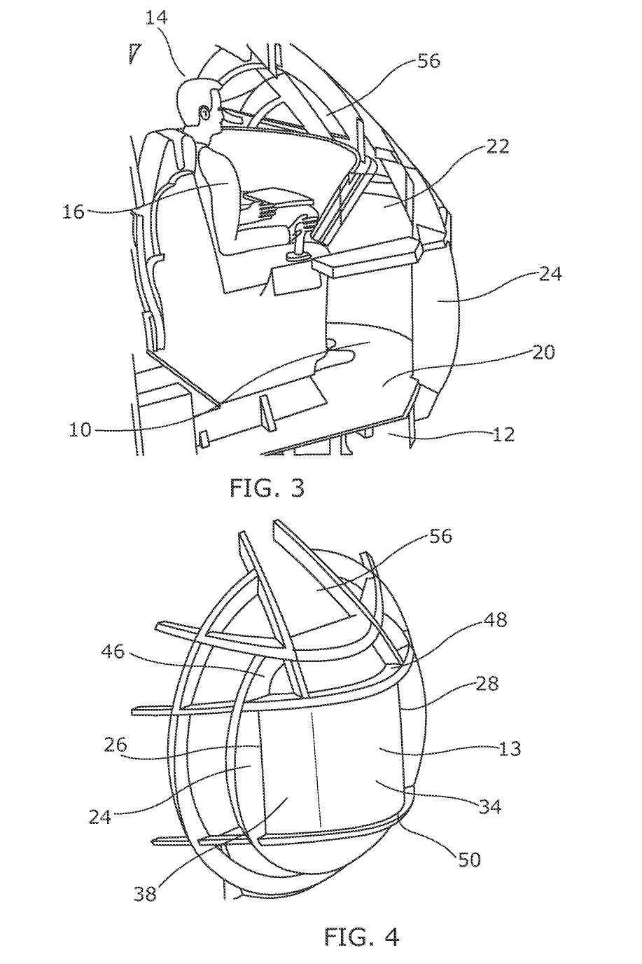

As shown in FIGS. 1 to 3, the cockpit 10 comprises a piloting station 14 in which a pilot 16 is arranged transversally centrally, namely positioned on the central longitudinal axis X-X passing through the end of the radome 8 of the aircraft 2. A copilot 18 (partially represented in FIGS. 2 and 3) is positioned offset, behind, and to one of the sides of the pilot 16. The co-pilot 18 can be only a simple assistant without piloting function. According to another example, the pilot 16 can also be located alone in the piloting station 14. Throughout the disclosure and various configurations, the pilot 16 arranged transversally at the centre of the cockpit 10 will be referred to by the term centered pilot.

Moreover, it is assumed that the aircraft 2 is arranged on a ground defining a horizontal plane. The aircraft 2 comprises a floor 20 arranged parallel to the ground, i.e. on a horizontal plane. The floor 20 is a floor for walking on for the members of the crew (pilot, co-pilot, piloting assistant, hostesses, etc.) and/or for the passengers. The cockpit 10 and the technical hold 12 are separated vertically by the floor 20. A vertical direction is a direction at right angles to the horizontal planes of the ground and of the floor 20.

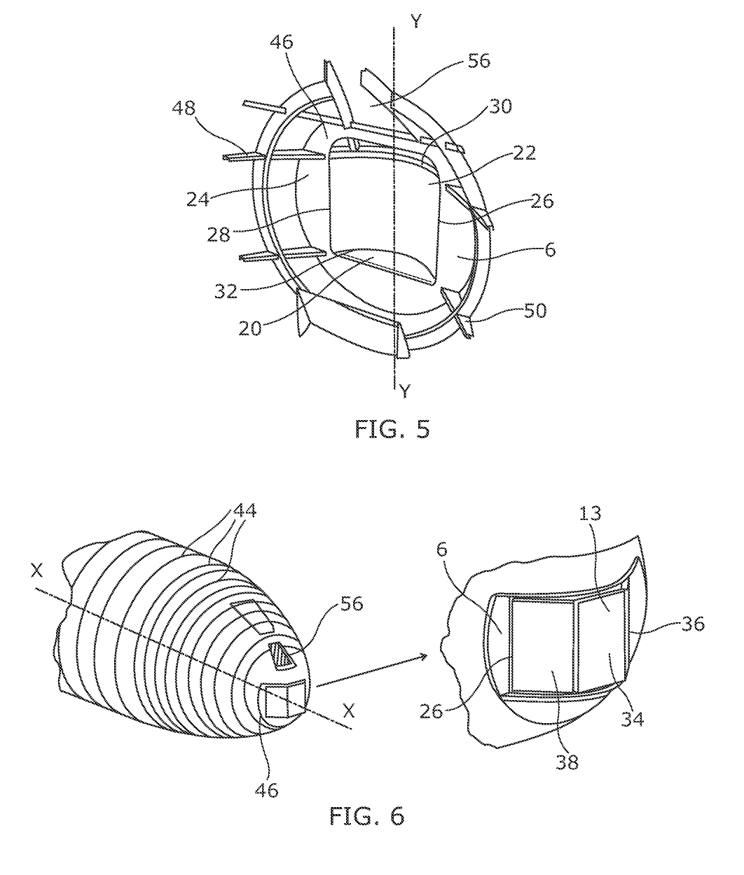

As shown in FIGS. 4 and 5, the sealed bottom 6 comprises two parts: a semi-cylindrical central part 22 (i.e. partially cylindrical) having elongated side edges that are at right angles to the floor 20, and having a concavity that is turned towards the interior of the aircraft 2, i.e. towards the piloting station 14, and a planar peripheral part 24 extending at least partially around the central part 22. The planar peripheral part 24 is vertical. The central part 22 protrudes relative to the peripheral part 24 towards the interior of the radome 8, i.e. towards the outside of the aircraft 2. The central 22 and peripheral 24 parts are symmetrical relative to the central vertical axis Y-Y (shown in FIG. 5) of the central part 22.

The semi-cylindrical central part 22 comprises two straight and mutually parallel lateral vertical edges 26, 28, and two curved and mutually parallel top 30 and bottom 32 horizontal edges. In the embodiment illustrated, the two curved and horizontal edges 30, 32 are semi-circular. The two straight and vertical lateral edges 26, 28 are located in a vertical plane P (shown in FIG. 8) at right angles to the central longitudinal axis X-X of the aircraft 2.

In the embodiment illustrated, the peripheral part 24 is located in the plane P. The central part 22 and the peripheral part 24 are linked at the vertical lateral edges 26, 28. The space between the curved edges 30, 32 and the plane P is open. Now, the sealed bottom 6 has to form a sealed closed bulkhead to offer a barrier to pressure. That is, the sealed bottom is therefore open when it is not assembled, and closed when it is assembled on the airplane, and the open spaces being filled by airplane components as will be further explained herein.

The peripheral part 24 extends from the lateral edges 26, 28 of the central part and from the projection of the bottom horizontal edge 32 of the central part on the plane P, to the fuselage of the aircraft. These portions extending from the lateral edges 26, 28 and from the projection of the edge 32 extend also towards one another to form a continuous planar half-ring partially surrounding the central part at the lateral and lower level. The top edge 30 of the central part 22 delimits the top edge of the sealed bottom 6 and there is therefore no peripheral part extending from the projection of the top edge of the central part 22 on the plane P. In fact, the space inside the aircraft which is located above the horizontal plane passing through the projection of the edge 30 on the plane “P” is in this case can be pressurized.

The top edge 30 of the central part 22 is linked directly or indirectly to the fuselage. According to other embodiments, the peripheral part 24 may extend from the bottom edge 32 and curved top 30 edge, or even only from the top edge 30. The same applies with regard to the peripheral parts extending from the lateral edges 26, 28 of the sealed bottom 6 or even the link portions between the lateral, top and bottom parts. The peripheral part 24 makes it possible to adapt the integration of the central part 22 in the aircraft according to the geometry of the front part 4 of the aircraft.

Moreover, the central part 22 moulds to the geometry of the radar antenna 13 while addressing the various constraints to which the sealed bottom 6 is subjected: resistance to the pressure difference between the radome 8 and the piloting station 14, structural integrity of the pressurized zone to withstand an impact (bird or the like), support for the radar antenna, optimization of the volumes, weight and complexity in a complex zone (windshield, floor, etc.).

Furthermore, the central part 22 of the sealed bottom 6 may be produced from a single-piece panel made of a composite material. The peripheral part 24 takes the form of a composite frame that is reinforced and fixed to the central part by any type of known means such as, for example, by screws. However, the parts 22 and 24 of the sealed bottom 6 can be produced in any other material such as, for example metal.

Moreover, the radome 8 comprises a radar with multi-plate antenna 13 of the type for example with electronic scanning as in the patent cited above. The radar antenna 13 comprises at least two plates having a planar surface arranged contiguously that can take forms, sizes and dimensions that are the same or varied. In the embodiment illustrated, the radar antenna 13 comprises a central plate 34 and two lateral plates 36, 38. The central plate 34, and the two lateral plates 36, 38 may be rectangular and of the same dimensions. The lateral plates 36, 38 are not located on the same plane as that of the central plate 34 but form an angle relative thereto. The angle formed by each of the lateral plates 36, 38 with the central plate 34 is identical, in which the radar antenna 13 is overall symmetrical relative to the axes of symmetry of the central plate 34. In the present case, the radar antenna 13 is symmetrical relative to the vertical longitudinal axis of symmetry and the horizontal transverse axis of symmetry of the central plate 34.

As shown in FIG. 8, the central part 22 of the sealed bottom 6 has a semi-cylindrical form moulding to the overall form of the central plate 34 and the lateral plates 36, 38 of the radar antenna 13. For each of the central plate 34 and the lateral plates 36, 38, there is at least one point of the central part 22 of the sealed bottom 6 which is contiguous to a point of the plate. The lateral end portions 40, 42 of the central part 22 of the sealed bottom 6 on the side of its lateral vertical edges 26, 28 are tangential to the lateral plates 36, 38 of the radar antenna 13. As shown in the embodiment of FIG. 8, the nearest points between the central part 22 and each of the lateral plates 36, 38 are, for the lateral plates 36, 38, those of the vertical lateral edges 26, 28 of the central part 22 and of the plates 36, 38 and, for the central plate 34, the points situated on the vertical axis of symmetry of the central part 22 and of the central plate 34.

Because of the proximity between the radar antenna 13 and the sealed bottom 6, the fixing of the central plate 34 and the lateral plates 36, 38 of the radar antenna 13 onto the central part 22 of the sealed bottom 6 is made simpler. There is no longer a need to design a particular attachment mechanism for the radar antenna 13. According to an illustrative embodiment, the radar antenna 13 can be fixed directly onto the central part 22 of the sealed bottom 6 by means such as, for example, screws and/or nut and bolts, and the central plate 34 and the lateral plates 36, 38 may be linked to one another along their vertical lateral edges.

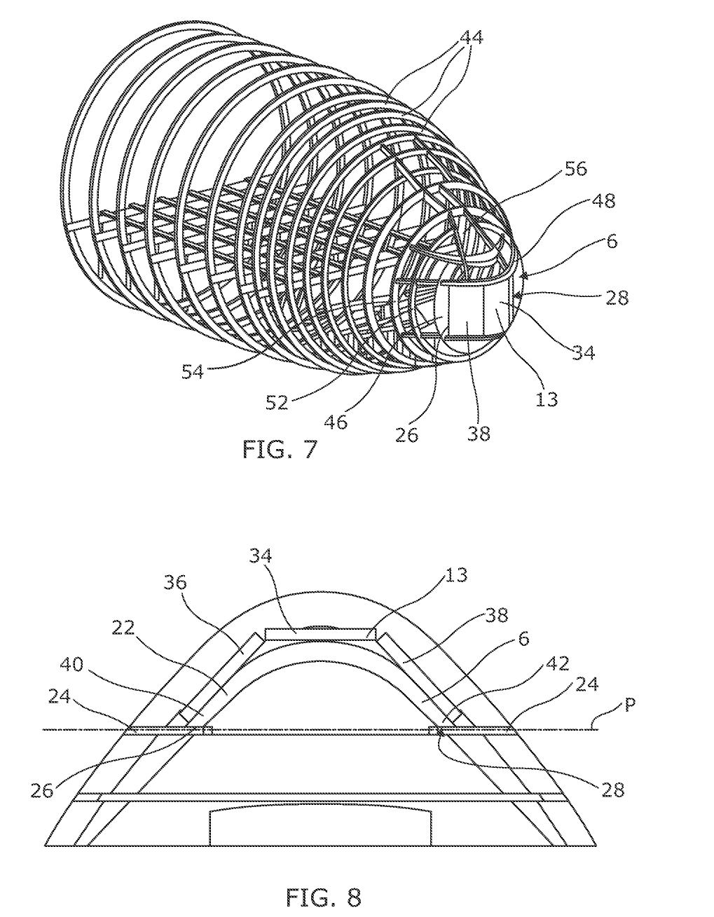

The integration of the sealed bottom 6 in the front part 4 of the aircraft is done in correlation with the positioning of the stiffeners therein. The sealed bottom 6 is positioned at the same level with stiffeners of the front part 4 to reinforce the rigidity thereof. As shown in FIG. 7, in the embodiment illustrated, the front part 4 of the aircraft comprises circumferential frames 44, and the foremost frame 46 is referred to as front end frame.

Referring back to FIG. 6, the sealed bottom 6 is arranged at the level of the front end frame 46, and the front end frame 46 is located in the plane P of the lateral edges 26, 28 of the central part 22 of the sealed bottom 6. The peripheral part 24 of the sealed bottom extending from the central part 22 to the fuselage partially forms the front end frame 46 which is therefore reinforced compared to the other frames of smaller dimensions. The peripheral part 24 extends, over a part of its circumference (namely at least below the top horizontal edge 30 of the central part 22), the front end frame 46 to the central part 22.

The top and bottom horizontal edges 30, 32 of the central part 22 are arranged at the same level as the longitudinal stiffeners 48, 50, and fixed to a part of the frames 46, 52, 54 of the front part 4. The stiffeners 48, 50 frame the central part at the top level and bottom level and link it to the fuselage of the aircraft in order to partition the radome. The bottom edge 32 of the central part 22 is contiguous to the front end edge of the floor 20 to which it is fixed (as seen in FIG. 5). This will ensure that the frames 46, the stiffeners 48, 50, and the floor 20 can absorb a portion of the forces exerted on the sealed bottom 6.

Moreover, the floor 20 closes the free space between the bottom edge of the central part and the peripheral part to form a completely tight-sealed closed bottom. The top edge of the peripheral part and of the central part are framed by the same longitudinal stiffener 48 which forms the link with the fuselage, and closes the free space on the top side of the sealed bottom. In the embodiment illustrated, the peripheral part is extended above the sealed bottom to enclose the frame 46 and give an overall annular form to the peripheral part forming a whole with the frame 46. In this case, the stiffener 48 is interrupted at the sealed bottom and fixed on either side thereto.

Referring back to FIGS. 2 to 8, the front part has a windshield 56 of very small size but the present disclosure can be applied to any other type of nose cone with wider windshield having one or more windows. Because of a central part 22 of the sealed bottom 6 protruding towards the outside of the aircraft relative to the vertical plane P of the front end frame 46, an additional volume is offered for the piloting station and in particular for the feet of the pilot 16, the floor 20 being located at the level of the bottom edge 32 of the central part 22 of the sealed bottom. It is thus possible to move the pilot 16 forward at the cockpit 10 level and to free up space for the cabin of the aircraft 2 in order to increase the number of passengers. It is also possible, for one and the same capacity in terms of number of passengers, to propose an airplane of smaller size.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A sealed bottom for a front aircraft part, comprising:
a semi-cylindrical central part,
two curved upper and lower edges parallel to one another,
two straight side edges parallel to one another,
a planar peripheral part extending at least partially around the semi-cylindrical central part, the planar peripheral part being located in a plane P of the straight edges of the semi-cylindrical central part and being linked thereto.

2. The sealed bottom according to claim 1, wherein the space between the two curved edges and the plane P in which the planar peripheral part is located is open.

3. A front part of an aircraft, comprising:
a piloting station for accommodating at least one centered pilot, delimited partially by a floor, comprising:
a sealed bottom comprising a semi-cylindrical central part having opposing straight lateral edges at right angles to the floor, and wherein the concavity is turned towards the piloting station, and having four edges that are parallel in pairs,
two curved top and bottom edges and the straight lateral edges, and a planar peripheral part extending at least partially around the central part, the peripheral part being located in the plane of the straight lateral edges of the central part and linked thereto.

4. The front part of an aircraft according to claim 3, wherein the peripheral part forms the link between the central part and the structure of the fuselage so as to close it in a seal-tight manner.

5. The front part of an aircraft according to claim 4, wherein the curved bottom edge of the central part is contiguous to the front end edge of the floor, and wherein the space between the bottom edge of the central part and the peripheral part is closed by the floor.

6. The front part according to claim 5, wherein the bottom and top edges of the central part are bracketed by longitudinal stiffeners of the front part and linked substantially directly thereto.

7. The part of an aircraft according to claim 6, wherein the peripheral part extends between the lateral edges of the central part and a front end frame of the fuselage.

8. The front part of an aircraft according to claim 7, wherein the peripheral part extends between the projection of the bottom edge of the central part on the plane P of the peripheral part and the front end frame of the fuselage.

9. The front part of an aircraft according to claim 8, wherein the peripheral part extends continuously at least partially around the central part.

10. An aircraft comprising a front part according to claim 3.

11. An aircraft nose structure, comprising:
a semi-cylindrical central part bounded by an upper curved edge, an opposing lower curved edge, a first linear side edge, and an opposing second linear side edge,
wherein the first and the second linear side edges extend along a vertical plane,
wherein the lower curved edge bounds a portion of a floor within the aircraft,
a planar peripheral part extending around the semi-cylindrical central part along the vertical plan
the planar peripheral part is attached to first and second linear edges and the upper and lower curved edges with an opening in a middle thereof providing access to the semi-cylindrical part, and
wherein the aircraft nose structure separates a pressurized portion within the cockpit on one side from a non-pressurized space housing the aircraft radome on the other side.

12. The aircraft nose structure according to claim 11, further comprising a plurality of longitudinal stiffeners supporting the semi-cylindrical central part and the peripheral planar part.
